(19) United States
(12) Patent Application Publication
(10) Pub. No.: US 2026/0027485 A1
(43) Pub. Date: Jan. 29, 2026

(54) FLAPPING DEVICE

(71) Applicant: NAKAKITA SEISAKUSHO CO. LTD., Osaka (JP)

(72) Inventor: Masaki HAMAMOTO, Osaka (JP)

(73) Assignee: NAKAKITA SEISAKUSHO CO. LTD., Oaka (JP)

(21) Appl. No.: 19/129,922

(22) PCT Filed: Nov. 14, 2023
(86) PCT No.: PCT/JP2023/040841

§ 371 Date: May 14, 2025

(30) Foreign Application Priority Data
Nov. 15, 2022 (JP) 2022-182369

(51) Int. Cl. A63H 27/00; B64C 33/02

(52) U.S. Cl. CPC A63H 27/008; B64C 33/02

(57) ABSTRACT

[Problem] To provide a flapping flying robot that is compact and is capable of performing flight with high mobility.

[Solution] A flapping device 1 has blades 2, 2 and a drive unit 3, and the drive unit 3 includes: a drive source 30; a driven part 10 rotated around a first rotation axial line by the drive source 30; a first vibration excitation member 40 biasing the driven part 10 in a direction opposite to a rotation direction of the driven part 10; and a control unit 60. The blade 2 has: a first blade shaft 20 extending in a predetermined axial line direction and being connected to the driven part 10 on a one end side and connected to be rotatable in a second rotation axial line surrounding direction intersecting the first rotation axial line; a second blade shaft 21 extending in a direction intersecting the first blade shaft 20 and being directly or indirectly connected to the driven part 10 on a one end side and connected to be rotatable in the first rotation axial line surrounding direction; and a blade main body 22 disposed over the first blade shaft 20 and the second blade shaft 21.

### TECHNICAL FIELD

The present invention relates to a flapping device that acquires a lift force by oscillating blades.

### BACKGROUND ART

Conventionally, flapping devices have been used for surveillance, photographing, various inspections, and the like from above. As the flapping device described above, a flapping blade micro-airplane system (hereinafter referred to simply as “flapping device”) that directly drives a flapping blade (corresponding to a blade) using a DC motor is known (for example, PTL 1).

Meanwhile, in recent years, flapping devices have been used also in toys and the like in accordance with diversification of uses. Moreover, for investigations, repairs, filming, and the like in confined spaces, there is a demand for compact flapping devices capable of flying in various flight modes. Here, since a lift force acting on blades depends on the length of the blades×the flapping frequency, in order for a small flapping flying robot to acquire a sufficient lift force, improvement of the flapping frequency is essential. However, in the configuration disclosed in PTL 1 described above, the flapping frequency is caused to be near the natural frequency (2*π*√(K/I)) (here, K is the spring constant of the torsion spring, and I is the rotational inertia of the entire system). For this reason, in PTL 1, emphasis is placed on making I as small as possible, and an in-runner type brushless DC motor or a brushed DC motor is used. Meanwhile, such motors have low power-to-weight ratios, and there are disadvantages that the former is high-priced, and the latter has a short lifespan. For this reason, although a combination with a torsion spring having a larger K, that is, a larger weight is demanded for increasing I, the realization of a configuration using an outrunner-type brushless DC motor having a high power-to-weight ratio with a low price is essential for implementation of a low cost. In addition, a larger I causes a flapping motion to be stabilized owing to a relative decrease of the influence of fluctuations in an aerodynamic load on the flapping motion, which also leads to an advantage that attitude control according thereto can be stably performed. Thus, the use of outrunner-type brushless DC motors in small flapping robots is currently being considered.

### CITATION LIST

### Patent Literature

PTL 1: U.S. Patent Application Publication No. 2016/159477

### SUMMARY OF INVENTION

### Technical Problem

However, in a case in which an outrunner-type motor is used without lowering the flapping frequency, K becomes large in accordance with large motor inertia, and thus the size of the spring is increased to increase the mass. Thus, in a case in which an outrunner-type motor is used, it is necessary to resist the restoring force of this large spring, and thus a higher offset voltage is required. As a result, there is concern that greater motor power is needed at the time of applying the offset. In this way, in the use of an outrunner-type motor, there is concern that motor power is necessary at the time of applying an offset to the motor that can be configured with a low cost and raise the power-to-weight ratio. Accordingly, there is a demand for a flapping device that is low-cost, compact, and capable of raising a power-to-weight ratio.

Thus, an object of the present invention is to provide a flapping device that can be configured with a low cost, is capable of raising a power-to-weight ratio, and can be configured compact. In addition, an object of the present invention is to provide a flapping device that can be realized with a low cost and be used also in toys and the like.

### Solution to Problem

(1) In order to solve the problems described above, according to the present invention, there is provided a flapping device including: a pair of blades; and drive units disposed in correspondence with the pair of blades, in which the drive unit includes: a drive source; a driven part receiving power output from the drive source and rotating around a first rotation axial line; a first vibration excitation member applying a biasing force to the driven part in a direction opposite to a rotation direction of the driven part in accordance with rotation of the driven part; and a control unit performing output control of a driving force of the drive source, and the blade has: a first blade shaft extending in a predetermined axial line direction and being connected to the driven part on a one end side and connected to be rotatable in a second rotation axial line surrounding direction intersecting the first rotation axial line; a second blade shaft extending in a direction intersecting the first blade shaft and being directly or indirectly connected to the driven part on a one end side and connected to be rotatable in the first rotation axial line surrounding direction; and a blade main body disposed over the first blade shaft and the second blade shaft.

The flapping device described above can excite the first blade shaft in the first rotation axial line surrounding direction using biasing using the first vibration excitation member. Thus, the flapping device described above can amplify the flapping frequency of one pair of blades through excitation and thus can drive the pair of blades at high speed. For this reason, a strong lift force can be acquired. For example, a torsion spring or the like capable of biasing torque in a torsional direction can preferably be used for the first vibration excitation member described above.

Since the flapping device described above can independently perform drive control of the pair of drive sources, flight in various directions can be performed. Here, although various motors and the like can be used as the drive sources, brushless DC motors that can be easily rotated in forward and reverse directions and have a high power-to-weight ratio are preferably used. In accordance with this, battery driving can be easily performed, and the control can be easily performed as well.

Here, in order to improve the flapping frequency, for example, increasing the spring constant of a torsion spring or the like used in the first vibration excitation member may be considered. However, in a case in which the spring constant of the first vibration excitation member (for example, the torsion spring) is raised, the restoring force also becomes strong, and thus there is a problem that larger motor power is necessary for offsetting the flapping amplitude center.

In other words, for example, in order to apply attitude control torque in a pitch (pitch-up/pitch-down) direction to the flapping device, it is necessary to offset the amplitude center of the first vibration excitation member to one side or the other side in the first rotation axial line surrounding direction (hereinafter, referred also to as a forward/backward direction). However, in a case in which the amplitude center of the first vibration excitation member is offset in the forward/backward direction of the first rotation axial line surrounding direction, there is a problem that it becomes difficult to perform offsetting in accordance with the restoring force of the first vibration excitation member. In addition, in a case in which the spring constant of the first vibration excitation member is raised, the restoring force becomes even stronger, and thus there is a problem that the offsetting described above becomes more difficult. For this reason, a flapping device capable of achieving power reduction at the time of controlling the drive unit while improving the flapping frequency has been demanded.

(2) Thus, in order to solve the problems described above, according to the present invention, there is provided a flapping device including: a pair of blades; and drive units disposed in correspondence with the pair of blades, in which the drive unit includes: a drive source; a driven part receiving power output from the drive source and rotating around a first rotation axial line; a first vibration excitation member applying a biasing force to the driven part in a direction opposite to a rotation direction of the driven part in accordance with rotation of the driven part; and a control unit performing output control of a driving force of the drive source, the blade has: a first blade shaft extending in a predetermined axial line direction and being connected to the driven part on a one end side and connected to be rotatable in a second rotation axial line surrounding direction intersecting the first rotation axial line; a second blade shaft extending in a direction intersecting the first blade shaft and being directly or indirectly connected to the driven part on a one end side and connected to be rotatable in the first rotation axial line surrounding direction; and a blade main body disposed over the first blade shaft and the second blade shaft, and the first vibration excitation member is connected to the driven part on a one end side and is directly or indirectly connected to the first blade shaft on the other end side.

In the flapping device described above, the one end side of the first vibration excitation member is connected to the driven part, and the other end side is directly or indirectly connected to the first blade shaft. In other words, the first vibration excitation member has a one end side not being fixed to the body that constitutes the flapping device but being fixed to the driven part. In other words, the one end side of the first vibration excitation member is configured as a free end.

In the flapping device described above, the one end side of the first vibration excitation member is formed as a free end, and thus, an offset can be applied to the flapping amplitude center described above without resisting the restoring force of the first vibration excitation member. Thus, according to the flapping device described above, even when the spring constant of the first vibration excitation member is raised, an offset can be applied to the flapping amplitude center without being influenced by the raised spring constant, and thus both improvement of the flapping frequency and suppression of power required at the time of control can be achieved.

In the flapping device described above, the second blade shaft is configured to be rotatable around the first rotation axial line, and thus, by driving the first blade shaft using the drive source, a stroke angle of the blade that has received a wind is passively defined as the angle of attack of the blade. In accordance with this, the flapping device described above can flexibly receive a wind using the blade main body and thus can efficiently acquire a lift force. Although any of various motors and the like can be used as the drive source described above, a brushless DC motor that can be easily rotated in forward and reverse directions and has a high power-to-weight ratio is preferably used. In accordance with this, battery driving can be easily performed, and the control can be easily performed as well.

Here, in a case in which an in-runner motor is used as the drive source, the inertia according to the rotor of the motor is small, and thus the influence of changes in the inertia of the blade applied to the blade shaft according to changes in the attitude (the angle of attack) of the blade becomes relatively large. In accordance with this, the resonant frequency greatly changes, and the resonance coefficient (the amplification factor of the blade amplitude) greatly changes furthermore, and thus changes in the blade amplitude need to be considered in control of the blade, and there is a problem that the control becomes complex. Thus, as a result of a further study of the inventors and the like, knowledge indicating that, when an outrunner motor having large inertia according to the rotor relative to an in-runner motor is used, the amount of change of the inertia of the first blade shaft according to an attitude change of the blade is small relative to large inertia of the rotor of an outrunner motor, and thus a change in the resonant frequency of the resonance system and a change in the blade amplitude become small, and the control can be easily performed was acquired.

(3) Thus, in the flapping device according to the present invention described above, the drive source may be configured using an outrunner motor as a DC motor.

The flapping device described above can reduce the cost of the drive source by using an outrunner motor that is less expensive than an in-runner motor. Therefore, by substituting two units of one pair of drive sources with outrunner motors, the flapping device described above can be expected to further reduce costs. In addition, by using the outrunner motor, the flapping device described above can reduce a change in the resonant frequency of the resonance system and a change in the blade amplitude, and thus further stabilization of the control can be expected.

Here, as a result of a diligent study of the inventors and the like, knowledge indicating that, in the flapping device described above, the electrical and mechanical conversion efficiency of the drive unit (for example, a motor) tends to decrease at the time of turnaround (switching between forward movement and backward movement) in the reciprocating motion of the blade was acquired. In the flapping device described above, in accordance with the restoring force of the first vibration excitation member, autonomous switching of the reciprocating motion is performed at a turnaround end in the reciprocating motion of the blade. For this reason, by stopping the motor at the turnaround end of the reciprocating motion of the blades and causing excitation to be performed only in an area near the flap center in which the angular velocity of the blades is high, the efficiency of the motor is considered to be improved.

(4) Thus, in the flapping device described above, the control unit may perform control of stopping output of a driving force of the drive source before a predetermined time at which a rotation speed of the drive source becomes zero in switching between forward rotation or backward rotation of the drive source and control of resuming the output of the driving force of the drive source after a predetermined time at which forward movement or backward movement is switched in the blade in accordance with a restoring force of the first vibration excitation member.

The flapping device described above performs control of stopping driving of the drive source before a predetermined time at which the rotation speed of the drive source becomes zero in switching between forward rotation or backward rotation of the drive source. In accordance with this, the drive according to the drive source can stop in a part in which the efficiency of the drive source decreases, and thus waste from the output of the drive source described above can be reduced, and the improvement of the electric cost of the drive battery can be expected. In this way, the flapping device described above can efficiently move the blade back and forth. In addition, the flapping device described above is configured to perform control of resuming the drive of the drive source after a predetermined time at which the forward movement or the backward movement is switched in the pair of the blades in accordance with the restoring force of the first vibration excitation member. In accordance with this, the flapping device described above can excite the blades in regions near the flap center in which the angular velocity of the blades is high. In addition, the flapping device described above can efficiently perform a flapping motion without increasing the capacity of the drive source. For this reason, downsizing of the flapping device described above can be expected.

(5) In the flapping device according to the present invention described above, the control unit may be able to execute offset control of offsetting an amplitude center of the first vibration excitation member to one side or the other side around the first rotation axial line by a predetermined amount, and the offset control is executed by applying a predetermined amount of offset to a drive voltage waveform of the drive source.

By applying a predetermined amount of offset to a drive voltage waveform of the drive source, the flapping device described above can easily execute offset control. For this reason, according to the flapping device described above, stabilization of control can be expected while performing high-precision control.

Here, in the flapping device described above, in a case in which the blade is stroked, in order to efficiently generate a lift force, it is preferable to incline the blade such that the vertical component of a normal-line vector facing in the direction of travel of the blade points downward.

(6) Thus, in the flapping device according to the present invention described above, the blade may have a rotation limiter for maintaining an inclination at a predetermined angle such that a vertical component of a normal-line vector of a blade surface facing a direction of travel points downward by receiving a resistance force according to a wind pressure generated in accordance with a relative speed difference between movement of the blade and a surrounding fluid.

By employing such a configuration, the flapping device described above can efficiently generate a lift force.

Here, in the offset control described above, in a case in which the one end side of the first vibration excitation member is formed as a free end, there is concern that the amplitude center of the vibration excitation member after offsetting would deviate from a scheduled amplitude center (also referred to as a reference position) in accordance with the excitation of the vibration excitation member. In other words, in a case in which the one end side of the first vibration excitation member is formed as a free end, the amplitude center is not fixed to the casing, and thus, there is a problem that the amplitude center is not mechanically set. For this reason, it is necessary to apply feedback control for returning the amplitude center to the reference position.

(7) Thus, the flapping device according to the present invention described above may further include: a body supporting the drive unit; and a second vibration excitation member applying a biasing force to the driven part in a direction opposite to the rotation direction of the driven part in accordance with rotation of the driven part, and the second vibration excitation member may be connected to the body on a one end side and be directly or indirectly connected to the first blade shaft on the other end side, and the second vibration excitation member may be formed to be able to exert a biasing force that is smaller than the biasing force of the first vibration excitation member and exert a biasing force capable of returning the amplitude center of the first vibration excitation member to a reference position.

By employing such a configuration, even when one end side of the first vibration excitation member is formed as a free end, the flapping device described above can return the amplitude center of the first vibration excitation member to the reference position (a scheduled amplitude center). In other words, in the flapping device described above, the first vibration excitation member is configured as a free end, and thus the amplitude center can be mechanically set. For this reason, according to the flapping device described above, even higher precision and stability of control can be expected.

Here, in a case in which the outrunner motor is used in the drive source, a rotator of an outer circumferential part rotates, and thus there is concern that the rotator and each part may interfere with each other.

(8) Thus, the flapping device according to the present invention described above further includes a body supporting the drive unit, in which the body may have a pair of support parts disposed spaced apart from each other, the drive source may be arranged outside of the pair of support parts, and the first vibration excitation member and the driven part may be arranged between the pair of support parts.

By employing such a configuration, in the flapping device described above, the pair of drive sources, the first vibration excitation member, and the driven part do not interfere with each other. For this reason, for example, in a case in which outrunner motors are used as drive sources, the flapping device described above can curb the rotators of the outrunner motors interfering with the first vibration excitation member and the driven part. In this way, even in a case in which rotators are exposed as in the case of outrunner motors, the flapping device described above can curb increase in the size of the device.

Here, in the flapping device according to the present invention described above, in a case in which the blade is inclined at a predetermined angle such that the vertical component of the normal-line vector of the blade surface facing a direction of travel points downward according to a wind pressure generated in accordance with a relative speed difference between movement of the blade and a surrounding fluid, it is necessary to incline the blade in accordance with the resistance force according to the wind while driving the first blade shaft. For this reason, it is necessary to allow the second blade shaft to be rotatable around the first rotation axial line by following the first blade shaft and incline the second blade shaft with respect to the first blade shaft.

(9) Thus, in the flapping device according to the present invention described above, an extension part may be formed to extend in the first rotation axial line direction on the one end side of the first rotation axial line, the second blade shaft may have a suspension part formed to extend toward the extension part on the one end side, and the suspension part may be connected to the extension part on a one end side and be rotatable in the first rotation axial line surrounding direction integrally with the extension part.

By employing such a configuration, in the flapping device described above, even in a case in which the second blade shaft is inclined with respect to the first blade shaft (for example, in a case in which the blade is formed in a fan shape), the second blade shaft can be supported to be rotatable around the first rotation axial line in accordance with the inclination direction. In accordance with this, in a case in which the blade receives a resistance force according to a wind, the flapping device described above can maintain the blade to be inclined at a predetermined angle such that the vertical component of the normal-line vector of the blade surface facing the direction of travel points downward. In addition, improvement of the degree of freedom in design and aerodynamic characteristics of the blade can be expected.

The torsion spring used in a flapping device has a property in which its natural angle gradually opens due to factors, for example, such as initial stress irregularities and the like. For this reason, in the flapping device, the stroke center of the blade deviates either forward or backward in accordance with the opening of the natural angle of the torsion spring, and thus there is a problem that the torque balance in the pitch direction is lost.

In addition, in the flapping device described above, there is concern that, as the torsion spring is opened, the diameter of the torsion spring increases, and the spring constant decreases as that much, which leads to a decrease in the resonant frequency in the flapping movement. As a result, the lift force of the flapping device decreases, and there is a problem that it becomes difficult for the flapping device to lift.

In addition, since a torsion spring has a property in which the spring constant is different in the rotation direction of a closing direction and the rotation direction of a loosening direction, even in a case in which initial irregularities do not occur, there is a problem that the problems described above occur.

(10) Thus, in the flapping device according to the present invention described above, the first vibration excitation member has at least one pair of torsion springs, and the pair of torsion springs may have equivalent spring constants and be connected in parallel such that torsional directions are opposite to each other.

In the flapping device described above, by employing such a configuration, loosening directions of the pair of torsion springs are configured to be directions opposite to each other, and thus the initial stress irregularities can be alleviated. In accordance with this, even in a case in which the natural angle of each of the torsion springs is opened, the degrees of opening counterbalance each other, and the flapping device described above can suppress changes in the natural angle of the torsion springs that are in a combined state.

In addition, in the flapping device described above, by employing such a configuration, the restoring forces of the torsion springs counterbalance each other, and thus changes in the natural angle can be decreased. In accordance with this, the flapping device described above can reduce changes in the diameters of the torsion springs in a combined state and suppress a decrease in the spring constant as a whole. In addition, since the torsion springs deform in opposite directions regardless of directions of variations, the flapping device described above can eliminate changes in the spring constant.

(11) The flapping device according to the present invention described above further includes a body supporting the drive unit, in which the first vibration excitation member may have at least one pair of torsion springs, the pair of torsion springs may have equivalent spring constants and be connected in parallel such that torsional directions are opposite to each other, and the pair of torsion springs may have a one end side being connected to the driven part such that the torsional directions are opposite to each other and the other end side being directly or indirectly connected to the body such that the torsional directions are opposite to each other.

In the flapping device described above, by employing such a configuration, loosening directions of the pair of torsion springs are configured to be directions opposite to each other, and thus the initial stress irregularities can be alleviated. In accordance with this, even in a case in which the natural angle of each of the torsion springs is opened, the degrees of opening counterbalance each other, and the flapping device described above can suppress changes in the natural angle of the torsion springs that are in a combined state.

In addition, in the flapping device described above, by employing such a configuration, the restoring forces of the torsion springs counterbalance each other, and thus changes in the natural angle can be decreased. In accordance with this, the flapping device described above can reduce changes in the diameters of the torsion springs in a combined state and suppress a decrease in the spring constant as a whole. In addition, since the torsion springs deform in opposite directions regardless of directions of variations, the flapping device described above can eliminate changes in the spring constant.

(12) In the flapping device according to the present invention described above, the first vibration excitation member has at least one pair of torsion springs, and the pair of torsion springs may have equivalent spring constants and be connected in series such that torsional directions are the same.

By employing the configuration described above, in the flapping device described above, the pair of torsion springs can cancel out mutual reaction forces. For this reason, in the flapping device described above, loosening directions of the pair of torsion springs can be cancelled out, and thus the initial stress irregularities can be alleviated. In accordance with this, in the flapping device described above, even in a case in which the natural angle of each of the torsion springs is opened, the degrees of opening counterbalance each other, and changes in the natural angle of the torsion springs that are in a combined state can be suppressed.

(13) The flapping device according to the present invention described above further includes a body supporting the drive unit, in which the first vibration excitation member may have at least one pair of torsion springs, the pair of torsion springs may have equivalent spring constants and be connected in series such that torsional directions are the same, and the first vibration excitation member may have a one end side being connected to the driven part and the other end side being directly or indirectly connected to the body.

By employing the configuration described above, in the flapping device described above, the pair of torsion springs can cancel out mutual reaction forces. For this reason, in the flapping device described above, loosening directions of the pair of torsion springs can be cancelled out, and thus the initial stress irregularities can be alleviated. In accordance with this, in the flapping device described above, even in a case in which the natural angle of each of the torsion springs is opened, the degrees of opening counterbalance each other, and changes in the natural angle of the torsion springs that are in a combined state can be suppressed.

### Advantageous Effects of Invention

According to the present invention, a flapping device that can be configured with a low cost, raise the power-to-weight ratio, and be configured in a small size can be provided. In addition, according to the present invention, a flapping device, which can be also used in toys and the like, that can be realized with a low cost can be provided.

### BRIEF DESCRIPTION OF DRAWINGS

FIG. 1 is a perspective view of a whole flapping device according to a first embodiment of the present invention.

FIG. 2 is a perspective view of the flapping device according to the first embodiment of the present invention that is viewed from an oblique rear side.

FIG. 3 is a partial cutout schematic configuration diagram of the flapping device according to the first embodiment of the present invention.

FIG. 4 is an explanatory diagram of drive of blades configuring the flapping device according to the first embodiment of the present invention.

FIG. 5 is an explanatory diagram of output characteristics of a motor used in the flapping device according to the present invention and an output area of the motor.

FIG. 6(a) is an explanatory diagram of a case in which the amplitude center is offset, and FIG. 6(b) is an explanatory diagram of offset control in the flapping device according to the first embodiment of the present invention.

FIG. 7 is a perspective view of a whole flapping device according to a second embodiment of the present invention.

FIG. 8 is a perspective view of the flapping device according to the second embodiment of the present invention that is viewed from an oblique rear side.

FIG. 9 is a partial cutout schematic configuration diagram of the flapping device according to the second embodiment of the present invention.

FIG. 10 is an explanatory diagram of offset control in the flapping device according to the second embodiment of the present invention.

FIG. 11 is a partial cutout schematic configuration diagram of a flapping device according to a third embodiment of the present invention.

FIG. 12(a) is a perspective view of a flapping device according to a fourth embodiment of the present invention that is viewed from an oblique front side, and FIG. 12(b) is a perspective view of the flapping device illustrated in FIG. 12(a) that is viewed in another direction.

FIG. 13 is a partially-omitted main-part enlarged perspective view of the flapping device according to the fourth embodiment of the present invention.

FIG. 14(a) is a partially-omitted main-part enlarged perspective view of a flapping device according to a fifth embodiment of the present invention, and FIG. 14(b) is a partially-omitted main-part enlarged perspective view of the flapping device illustrated in FIG. 14(a) that is viewed in another direction.

FIG. 15 is a perspective view illustrating an example of a flapping device having high mobility to which the configuration of the flapping device according to the fourth embodiment and the fifth embodiment of the present invention can be applied.

### DESCRIPTION OF EMBODIMENTS

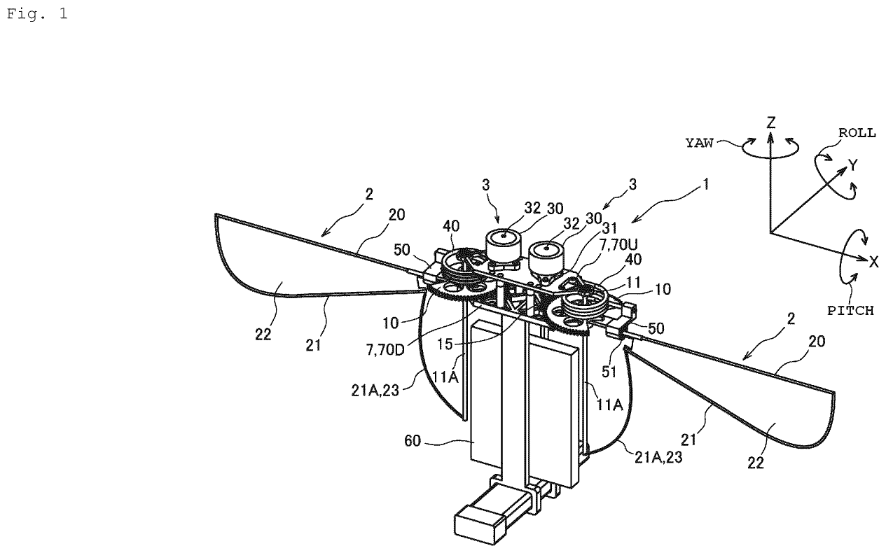

Hereinafter, details of a flapping device 1 according to a first embodiment of the present invention will be described with reference to the attached drawings. These figures are schematic diagrams and do not necessarily describe sizes in exact proportions. Note that similar reference signs are assigned to similar components in the drawing. As illustrated in FIG. 1, an illustrated vertical direction is set as a Z direction, a rightward/leftward direction is set as an X direction, and an illustrated depth direction is set as a Y direction, and rotation in a direction around a Z axis may be denoted as a yaw direction, rotation in a direction around an X axis may be denoted as a pitch direction, and rotation in a direction around a Y axis may be denoted as a roll direction.

### First Embodiment

As illustrated in FIGS. 1 to 3, the flapping device 1 has a pair of blades 2, 2 and drive units 3, 3 disposed for each of the pair of blades 2, 2. Each of the drive units 3, 3 is supported by a body 7. The flapping device 1 according to this embodiment is configured to acquire a lift force toward an upper side by driving the pair of blades 2, 2 to reciprocate in a horizontal direction (a forward/backward direction in the drawing). Since the pair of blades 2, 2 and the pair of drive units 3, 3 are symmetrically arranged horizontally, in the following description, in a case in which there is no particular need to distinguish between sides, a horizontal one side (a right side) will be described, and description of the other side (a left side) will be omitted. Note that, in FIGS. 1 to 3, an illustrated upper side may be described as an upper side (a U side), and an illustrated lower side may be described as a lower side (a D side).

The body 7 has a pair of support parts 70U, 70D spaced apart in a vertical direction. In this embodiment, each of the support parts 70U, 70D is formed of a plate-shaped member.

The drive unit 3 has a drive source 30, a driven part 10, a first vibration excitation member 40, and the like. A control unit 60 performing drive control of the drive source 30 is connected to the drive unit 3. In this embodiment, the drive source 30 is configured using an outrunner motor in a DC motor. Illustration and description of a power source (battery) for driving the drive source 30 are omitted.

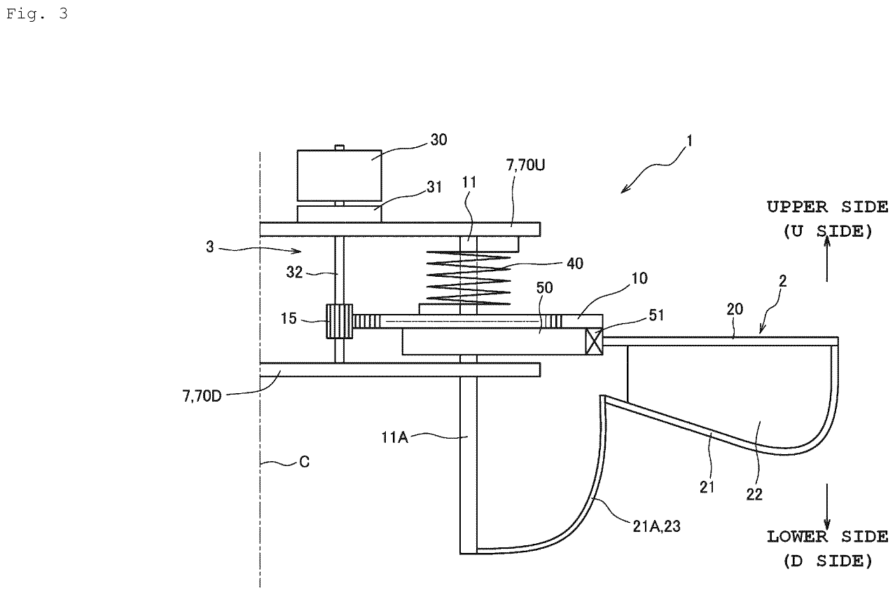

The drive source 30 is supported on an outer face of the support part 70U located on an upper side through a pedestal 31. In this embodiment, a pair of drive sources 30, 30 are arranged to be horizontally symmetrical with respect to a center line C (see FIG. 3).

As illustrated in FIG. 3, a drive shaft 32 of the drive source 30 is rotatably supported by the support part 70U through an appropriate bearing (not illustrated in the drawing). In addition, a tip end side of the drive shaft 32 is rotatably supported by the support part 70D through an appropriate bearing (not illustrated in the drawing). In addition, a drive gear 15 as a pinion gear is externally fitted in a middle part of the drive shaft 32.

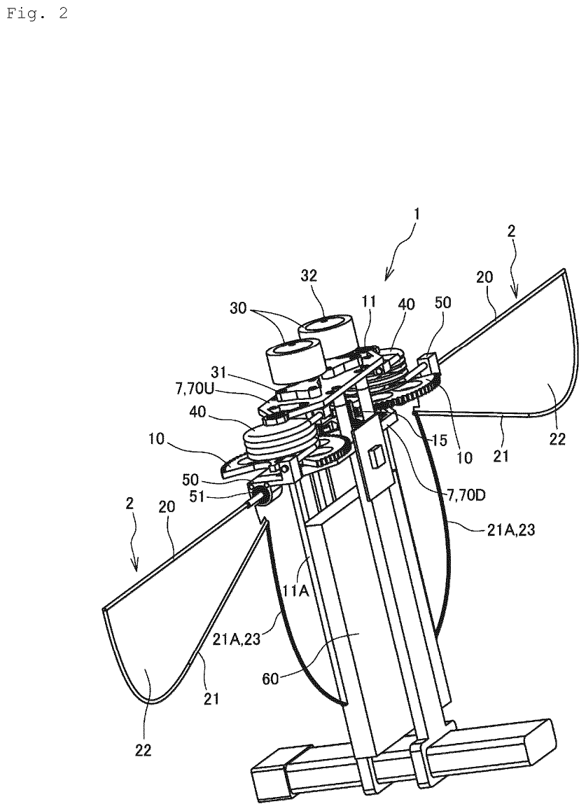

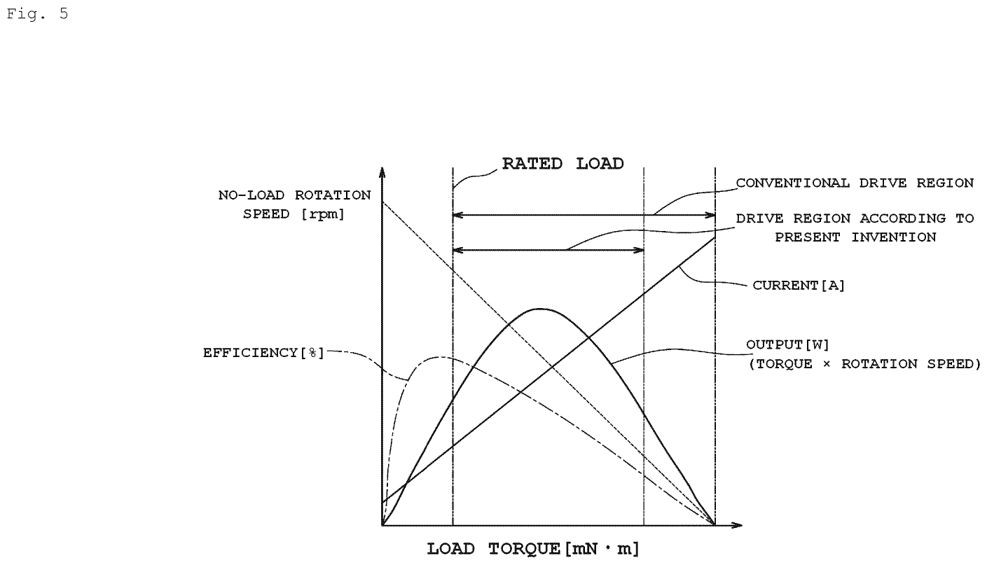

As illustrated in FIGS. 1 and 2, the driven part 10 is formed of a spur gear with a partially notched part. The notched part of the driven part 10 is formed to suppress interference with the blades 2 and the like. The driven part 10 is supported by the support part 70U to be rotatable in an axial line surrounding direction of a first rotation shaft 11. More specifically, in this embodiment, the first rotation shaft 11 is rotatably supported by the support part 70U and the support part 70D, and the driven part 10 is fixed to the first rotation shaft 11 through press fitting or the like. In this embodiment, the driven part 10 is arranged near the support part 70D side. The driven part 10 is engaged with the drive gear 15 and can rotate in an axial line surrounding direction of the first rotation shaft 11 (see FIG. 5) (also referred to as a first rotation axial line surrounding direction) by receiving power output from the drive source 30.

The first rotation shaft 11 is supported by the support part 70U and the support part 70D to be rotatable, and, on one end side thereof, an extension part 11A is formed to extend along the first rotation axial line direction. More specifically, the extension part 11A is formed by extending the one end side of the first rotation shaft 11 to the outer side through the support part 70D. A suspension part 21A to be described below is connected to a one end side (a rear end side) of the extension part 11A.

A blade shaft holding part 50 for holding a first blade shaft 20 to be described below is supported on the driven part 10. The blade shaft holding part 50 is configured to rotate in the first rotation axial line surrounding direction integrally with the driven part 10.

A bearing 51 is supported by the blade shaft holding part 50 to face a radial-direction outer side of the driven part 10. In other words, the bearing 51 is supported by the driven part 10 in a direction intersecting the first rotation shaft 11 (in this embodiment, an orthogonal direction; hereinafter, also referred to as a second axial line surrounding direction). The first blade shaft 20 to be described below is supported by the bearing 51 such that the first blade shaft 20 can rotate in the second axial line surrounding direction.

As illustrated in FIGS. 1 to 3, the first vibration excitation member 40 is formed of a torsion spring and is arranged between the support part 70U and the driven part 10. The first vibration excitation member 40 is arranged around the axial line of the first rotation shaft 11. The first vibration excitation member 40 is configured to apply a biasing force to the driven part 10 in a direction opposite to the rotation direction of the driven part 10 in accordance with the rotation of the driven part 10. More specifically, the first vibration excitation member 40 has one end side (a front end side) being connected to the support part 70U and the other end side (a rear end side) being connected to the driven part 10. Therefore, the first vibration excitation member 40 can apply a biasing force in the direction opposite to the direction of rotation of the driven part 10 in accordance with the rotation of the driven part 10.

The blade 2 has a first blade shaft 20, a second blade shaft 21, a blade main body 22, and the like.

The first blade shaft 20 is formed to extend in a predetermined axial line direction (in this embodiment, in the radial direction of the first rotation shaft 11). The first blade shaft 20 is connected to the driven part 10 on the one end side and is rotatably connected in the second rotation axial line surrounding direction intersecting the axial line of the first rotation shaft 11. More specifically, the first blade shaft 20 is rotatably supported by the bearing 51 of the blade shaft holding part 50 on the one end side. Thus, the first blade shaft 20 can rotate in the first rotation axial line surrounding direction and the second rotation axial line surrounding direction. In addition, a biasing force according to the first vibration excitation member 40 is applied to the first blade shaft 20 in a direction opposite to the rotation direction in accordance with the rotation of the driven part 10. In accordance with this, the first blade shaft 20 is excited in the rotation direction of the driven part 10 (the first rotation axial line surrounding direction).

The second blade shaft 21 is formed to extend in a predetermined axial line direction (in this embodiment, a direction inclined at a predetermined inclination angle with respect to the first blade shaft 20). The second blade shaft 21 has a suspension part 21A formed to extend toward the extension part 11A on one end side.

The suspension part 21A, for example, is formed using a resin having predetermined flexibility or the like as the material thereof. The suspension part 21A has the one end side being connected to the second blade shaft 21 and the other end side being connected to a lower end side of the extension part 11A through bending. In other words, the suspension part 21A is configured to be able to rotate in the first rotation axial line surrounding direction integrally with the extension part 11A. Accordingly, the second blade shaft 21 can rotate in the first rotation axial line surrounding direction integrally with the suspension part 21A. In addition, the suspension part 21A also has a function as a rotation limiter 23 to be described below, which maintains the second blade shaft 21 not to be inclined at a predetermined angle or more.

In accordance with this, even in a case in which the second blade shaft 21 is inclined with respect to the first blade shaft 20 (for example, in a case in which the blade 2 is formed in a fan shape), the flapping device 1 described above can support the second blade shaft 21 to be rotatable around the first rotation axial line in accordance with the inclination direction. In accordance with this, in a case in which the blade 2 receives a resistance force due to a wind pressure caused by a relative speed difference between the movement of the blade 2 and the surrounding fluid, the flapping device 1 described above can incline the blade 2 at a predetermined angle such that the vertical component of the normal-line vector of the blade surface facing the direction of travel points downward. In addition, the degree of freedom in design and the aerodynamic characteristics of the blade 2 can be expected to be improved.

In addition, a biasing force according to the first vibration excitation member 40 is applied to the second blade shaft 21 together with the first blade shaft 20 in a direction opposite to the rotation direction in accordance with the rotation of the driven part 10. In accordance with this, the second blade shaft 21 is excited in the rotation direction of the driven part 10 (the first rotation axial line surrounding direction).

The blade main body 22 is disposed over the first blade shaft 20 and second blade shaft 21. In this embodiment, the blade main body 22 is formed in an approximate fan shape. The blade main body 22 oscillates to reciprocate by driving the drive source 30, thereby being able to generate a lift force.

The control unit 60 is configured to perform output control of a driving force according to the drive source 30. In other words, by performing output control of the driving force according to the drive source 30, a reciprocating motion is given to the blade 2.

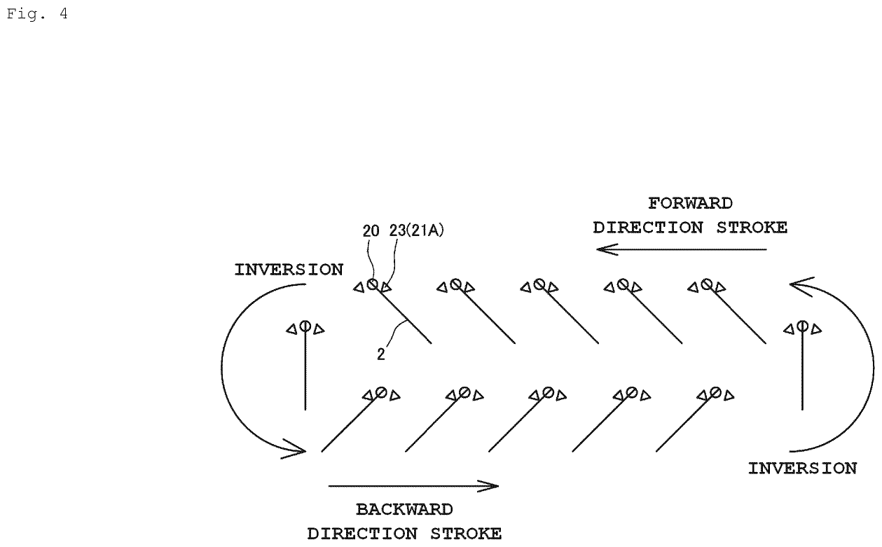

FIG. 4 is an explanatory diagram illustrating the movement of the blade 2 of a case in which the control unit 60 performs drive control of the drive source 30 with a predetermined output. The example illustrated in FIG. 4 is a drawing schematically illustrating changes in the inclined state of the blade 2 between a case in which the blade 2 is stroked in a forward (lower side) direction (an upper stage in the drawing) and a case in which the blade 2 is stroked in a backward (upper side) direction (a lower stage in the drawing). In the illustration, a circle mark represents the first blade shaft 20, and a triangle mark represents the rotation limiter 23 (corresponding to the suspension part 21A in this embodiment) that restricts the movement of the blade 2. In addition, as the rotation limiter 23, various means such as a means for limiting rotation of the first rotation shaft 11 and the like can be employed.

The blade 2 is configured to be inclined to passively form the angle of attack in accordance with a resistance force (wind force) received by the blade main body 22 in a case in which the blade 2 is stroked in a forward direction or a backward direction. More specifically, the blade 2 is configured to be inclined at a predetermined angle (for example, 30 degrees) such that, in a case in which the blade 2 receives a resistance force due to a wind pressure caused by a relative speed difference between the movement of the blade 2 and the surrounding fluid, the vertical component of the normal-line vector of the blade surface facing the direction of travel points downward. The inclination of the blade 2 at the predetermined angle is maintained by the rotation limiter 23. In accordance with this, the flapping device 1 described above can efficiently generate a lift force. The inclination angle of the blade 2 may be appropriately changed by changing the setting of the rotation limiter 23 in correspondence with the flight mode.

Here, by controlling the output of the drive source 30, for example, such that the amplitudes of the pair of the blades 2, 2 are increased or decreased to be the same, the control unit 60 can increase or decrease the lift force. In addition, for example, by controlling the outputs of the drive sources 30, 30 such that there is a difference between the amplitudes of the pair of blades 2, 2, the control unit 60 can generate a torque (a driving force) in the roll direction in accordance with a difference between right and left lift forces.

In addition, the control unit 60 is configured to be able to execute offset control of offsetting the amplitude center of the first vibration excitation member 40 to one side or the other side around the first rotation axial line by a predetermined amount.

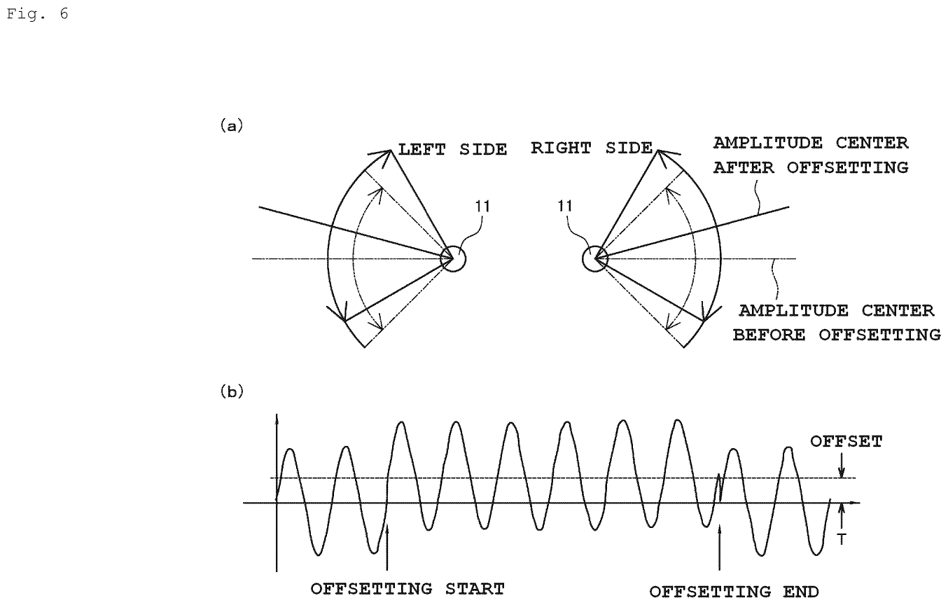

FIG. 6(a) is an explanatory diagram of a case in which the amplitude center of the first vibration excitation member 40 is offset. Note that, in FIG. 6(a), an angle by which the amplitude center of the first vibration excitation member 40 is offset is drawn in an exaggerated manner for ease of understanding. The offset control described above is configured to offset the amplitude center of the first vibration excitation member 40 in a forward/backward direction (in this embodiment, a solid line position on the front side). In other words, the offset control described above is configured to bias the center of the lift force in the forward/backward direction (in this embodiment, to the front side).

More specifically, as illustrated in FIG. 6(b), the offset control described above can be executed by applying an offset of a predetermined amount T to a drive voltage waveform (also referred to as an output waveform) of the drive source 30. The application of an offset to a drive voltage waveform can be executed, for example, by configuring a difference between the output of the drive voltage for a forward direction and the output of the drive voltage for a backward direction. In addition, in PWM control that is frequently used actually in motor control, this may be rephrased with configuring a difference between a motor drive duty ratio of a forward path and a motor drive duty ratio of a backward path. In other words, the amplitude center of the first vibration excitation member 40 is offset (see FIG. 6(a)). In accordance with this, the control unit 60 can generate torque in a pitch direction. Here, the angle by which the amplitude center of the first vibration excitation member 40 is offset, for example, may be 5 to 10 degrees. In the flapping device 1 according to the first embodiment, in a case in which the offset described above is applied, it is necessary to increase the output of the drive sources 30 against the first vibration excitation member 40. Depending on the flight mode of the flapping device 1, the offset amounts of the one pair of drive sources 30, 30 may be the same or different from each other.

In addition, the control unit 60 can generate torque in a yaw direction, for example, by controlling the outputs of the drive sources 30, 30 such that there is a difference in speeds in the forward and backward directions in a reciprocating motion and by controlling the outputs of the drive sources 30, 30 such that differences in speeds between the right and left blades 2, 2 are in opposite directions.

FIG. 5 is an explanatory diagram of output characteristics of the drive source 30 and an output area used by the flapping device 1 according to the present invention. As illustrated in the drawing, in a case in which a motor (in this embodiment, an outrunner motor) is used as the drive source 30, the electrical and mechanical conversion efficiency of the drive source 30 tends to decrease at the time of turnaround (switching between forward movement and backward movement) in the reciprocating motion of the blade 2. In the flapping device 1 described above, in accordance with the restoring force of the first vibration excitation member 40, autonomous switching of the reciprocating motion is performed at a turnaround end in the reciprocating motion of the blade 2.

Thus, in this embodiment, the control unit 60 performs control of stopping the output of a driving force of the drive source 30 before a predetermined time at which the rotation speed of the drive source 30 becomes zero in switching between forward rotation or reverse rotation of the drive source 30. Here, the predetermined time described above can be arbitrarily set in accordance with the characteristics (for example, the efficiency of output) of the drive source 30 that is used. Together therewith, the control unit 60 is configured to perform control of resuming the output of the driving force according to the drive source 30 after a predetermined time at which the forward movement or the backward movement is switched in the blade 2 in accordance with the restoring force of the first vibration excitation member 40.

In accordance with these, the drive according to the drive source 30 can stop in a part in which the efficiency of the drive source 30 decreases, and thus waste from the output of the drive source 30 can be reduced, and the improvement of the electric cost of the drive battery can be expected. In this way, the flapping device 1 described above can efficiently move the blades 2 back and forth. The flapping device 1 described above is configured to perform control of resuming the drive of the drive source 30 at a time point at which the forward movement or the backward movement is switched in the pair of the blades 2, 2 in accordance with the restoring force of the first vibration excitation member 40. In accordance with this, the flapping device 1 described above can excite the blades 2 in regions near the flap center in which the angular velocity of the blades 2 is high. In addition, the flapping device 1 described above can efficiently perform a flapping motion without increasing the capacity of the drive source 30. For this reason, downsizing of the flapping device 1 described above can be expected.

The configuration of the flapping device 1 according to the first embodiment of the present invention has been described as above. In the description presented above, the configurations of parts that are horizontally symmetrically arranged are similar to each other, and thus description thereof is omitted. Next, operations and effects of the flapping device 1 according to the first embodiment of the present invention are described below.

The flapping device 1 described above can excite the first blade shaft 20 in the first rotation axial line surrounding direction using biasing using the first vibration excitation member 40. Thus, the flapping device 1 described above can amplify the flapping frequency of one pair of blades 2, 2 through excitation and thus can drive the pair of blades 2, 2 at high speed. For this reason, a strong lift force can be acquired. In addition, as the first vibration excitation member 40 described above, for example, a member such as a torsion spring that can bias torque in a torsional direction can preferably be used.

Since the flapping device 1 described above can independently perform drive control of the pair of drive sources 30, 30, flight in various directions can be performed. Here, although any of various motors and the like can be used as the drive source 30, a brushless DC motors that can be easily rotated in forward and reverse directions and have a high power-to-weight ratio can be preferably used. In accordance with this, battery driving can be easily performed, and control can be easily performed as well.

In this embodiment, in the flapping device 1 described above, the drive source 30 is configured using outrunner motors as DC motors. For this reason, the flapping device 1 described above can increase the inertia according to a rotor that constitutes the motor. In accordance with this, the flapping device 1 described above can reduce a change in the resonant frequency of the resonance system and a change in the blade amplitude, and thus the control is stabilized. Therefore, the flapping device 1 described above can reduce the influence of disturbances (for example, an air current) received by the flapping device 1, and further stabilization of the control can be expected.

The flapping device 1 described above can reduce the cost of the drive source 30 by using an outrunner motor that is less expensive than an in-runner motor. Therefore, by substituting the one pair of right and left drive sources 30, 30 with outrunner motors, the flapping device 1 described above can be expected to further reduce costs.

The flapping device 1 described above has the body 7 supporting the drive source 30, and the body 7 has a pair of support parts 70U, 70D that are arranged to be spaced apart. In addition, the drive source 30 is located outside the pair of support parts 70U, 70D, and the first vibration excitation member 40 and the driven part 10 are arranged between the pair of support parts 70U, 70D.

In accordance with this, in the flapping device 1 described above, the drive source 30, the first vibration excitation member 40, and the driven part 10 do not interfere with each other. For this reason, the flapping device 1 described above can suppress the rotor of the outrunner motor from interfering with the first vibration excitation member 40 and the driven part 10, for example, in a case in which an outrunner motor is used as the drive source 30. In this way, the flapping device 1 described above can suppress an increase in the size of the device even in a case in which the rotor is exposed as in the case of an outrunner motor.

The configuration and the operations and the effects of the flapping device 1 according to the first embodiment of the present invention have been described above, and, next, details of a flapping device 100 according to a second embodiment of the present invention are described. The configuration of the flapping device 100 according to the second embodiment is similar to that of the flapping device 1 described above except that the way the flapping device 1 described above and the first vibration excitation member 40 are connected and the arrangement of each component are partially different, and thus, description of similar parts is omitted. Note that the same reference signs are used for the same components as those of the flapping device 1 described above. In addition, since the flapping device 100 is horizontally symmetrically configured, one side will be described, and description of the other side will be omitted.

In the flapping device 1 according to the first embodiment described above, the one end side of the first vibration excitation member 40 is connected to the support part 70U, and the other end side is connected to the driven part 10. Here, in order to increase the flapping frequency of the flapping device 1 for reducing the effect of disturbances, for example, the spring constant K of torsion springs or the like used in the first vibration excitation member 40 may be considered to be increased. However, in a case in which the spring constant K of the first vibration excitation member 40 is raised, the restoring force also becomes stronger, resulting in a larger load, and there is concern that it would become difficult to stroke the first blade shaft 20 and the second blade shaft 21. As a result, there is concern that the lift force would be reduced. Thus, an object of the second embodiment is to provide a flapping device 100 that can further improve the lift force and stabilize control by suppressing the concerns relating to the first embodiment.

### Second Embodiment

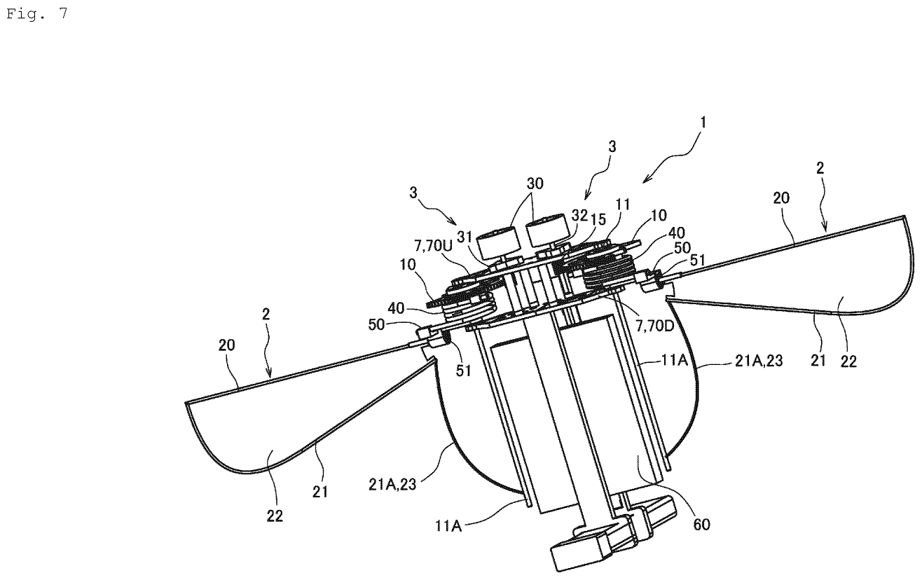

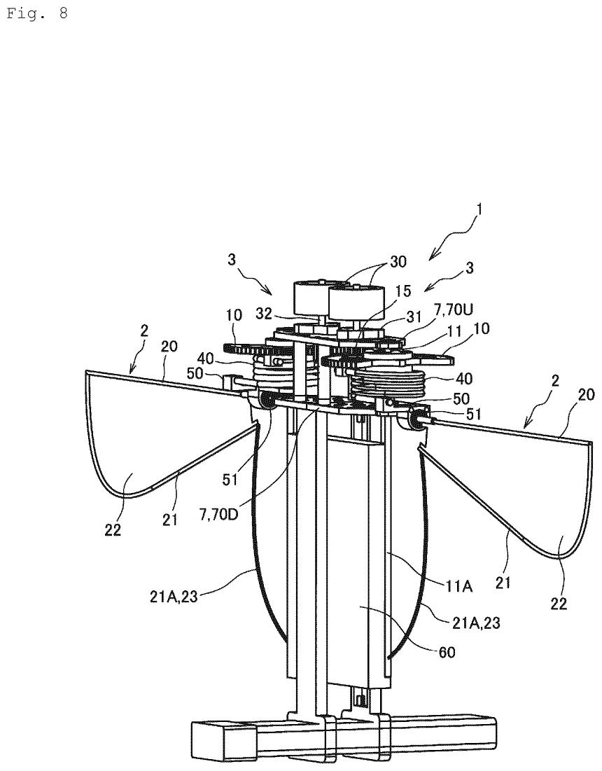

As illustrated in FIGS. 7 to 9, the flapping device 100 according to the second embodiment has a pair of blades 2, 2 and drive units 3, 3 disposed respectively in correspondence with the pair of blades 2, 2. The drive unit 3 includes a drive source 30, a driven part 10, a first vibration excitation member 40, and the like. A control unit 60 performing drive control of the drive source 30 is connected to the drive unit 3.

The first vibration excitation member 40 of the flapping device 100 has one end side being connected to the driven part 10 and the other end side being directly or indirectly connected to a first blade shaft 20. More specifically, the first vibration excitation member 40 has one end side being connected to the driven part 10 and the other end side being connected to a blade shaft holding part 50. In other words, the one end side of the first vibration excitation member 40 is not fixed to the body 7 constituting the flapping device 100 but fixed to the driven part 10. In other words, the one end side of the first vibration excitation member 40 is formed as a free end. In addition, in the second embodiment, the driven part 10 is supported to be rotatable with respect to the first rotation shaft 11.

The configuration of the flapping device 100 according to the second embodiment of the present invention has been described as above, and, similar to the first embodiment, the flapping device 100 can offset the amplitude center of the first vibration excitation member 40. In other words, the flapping device 100 according to the second embodiment can execute the offset control described above.

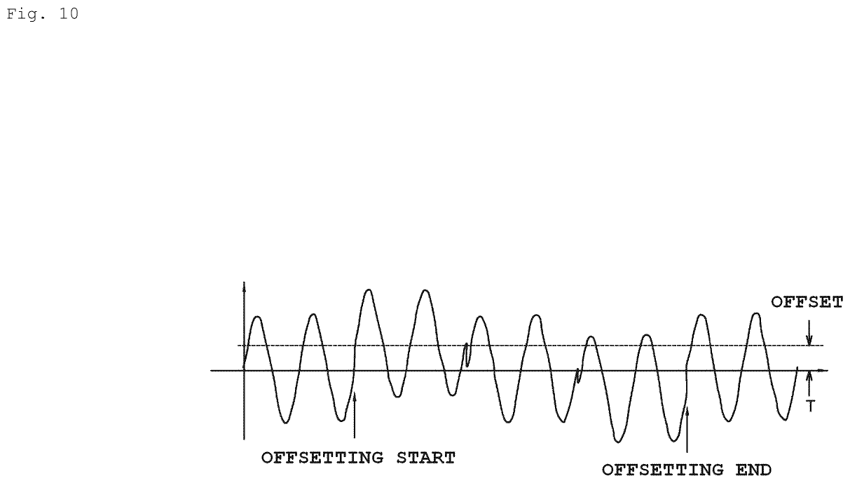

As illustrated in FIG. 10, the offset control described above can be executed by applying an offset of a predetermined amount T to a drive voltage waveform (an output waveform) of the drive source 30. Depending on the flight mode of the flapping device 100, the offset amount of the drive source 30 can be appropriately changed.

In this way, by applying an offset of a predetermined amount T to the drive voltage waveform of the drive source 30, the flapping device 100 described above can easily execute offset control. For this reason, according to the flapping device 100 described above, stabilization of control can be expected while performing high-precision control. In addition, in the flapping device 100 according to the second embodiment, one end side of the first vibration excitation member 40 forms a free end, and thus an offset can be easily applied to the flapping amplitude center without resisting the restoring force of the first vibration excitation member 40. In other words, also in a configuration in which the spring constant K of the first vibration excitation member 40 is relatively large, and the restoring force is relatively large, large motor power is not required at the time of applying an offset to the flapping amplitude center, and thus both a high flapping frequency and motor power reduction at the time of performing control can be achieved.

The configuration of the flapping device 100 according to the second embodiment of the present invention has been described as above, and, next, details of operations and effects of the flapping device 100 are described.

As described above, the flapping device 100 can excite the first blade shaft 20 without being affected by the restoring force of the first vibration excitation member 40 even in a case in which torque (a biasing force) is applied to the first vibration excitation member 40. In other words, the flapping device 100 described above can directly apply torque to the first blade shaft 20. In accordance this this, stabilization of the output control of the drive source 30 can be expected. For example, a torsion spring or the like capable of biasing torque in a torsional direction can preferably be used for the first vibration excitation member 40 described above.

In addition, in the flapping device 100 described above, since the second blade shaft 21 is configured to be rotatable around the first rotation axial line, by driving the first blade shaft 20 using the drive source 30, the stroke angle of the blade 2 that has received a wind is passively defined as the angle of attack of the blade 2. In accordance with this, the flapping device 100 described above can flexibly receive a wind using the blade main body 22 and thus can efficiently acquire a lift force. Although any of various motors and the like can be used as the drive source 30 described above, a brushless DC motor that can be easily rotated in forward and reverse directions and has a high power-to-weight ratio can be preferably used. In accordance with this, battery driving can be easily performed, and the control can be easily performed as well.

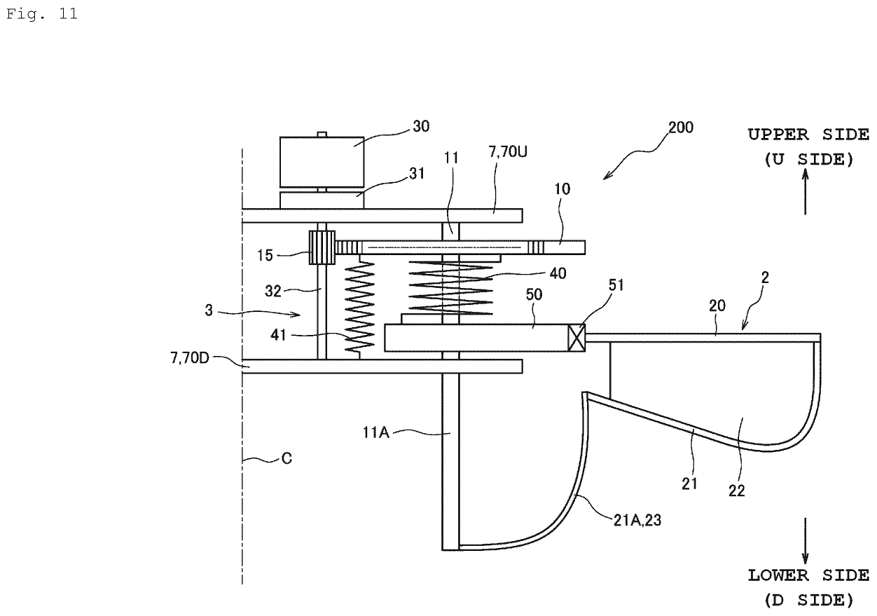

Here, in the offset control described above, the one end side of the first vibration excitation member 40 is formed as a free end. For this reason, there is concern that the amplitude center of the first vibration excitation member 40 after offsetting would deviate from a scheduled amplitude center (also referred to as a reference position) in accordance with the excitation of the first vibration excitation member 40. Thus, as illustrated in FIG. 11, in a flapping device 200 according to a third embodiment, a second vibration excitation member 41 is further provided, and the amplitude center of the first vibration excitation member 40 after offsetting is returned to the reference position. Hereinafter, details of the flapping device 200 according to the third embodiment will be described. Since the flapping device 200 according to the third embodiment is acquired by disposing the second vibration excitation member 41 in the flapping device 100 according to the second embodiment, description of parts similar to those of the flapping device 100 according to the second embodiment is omitted. Since the flapping device 200 according to the third embodiment is horizontally symmetrically configured, one side will be described and description of the other side will be omitted.

### Third Embodiment

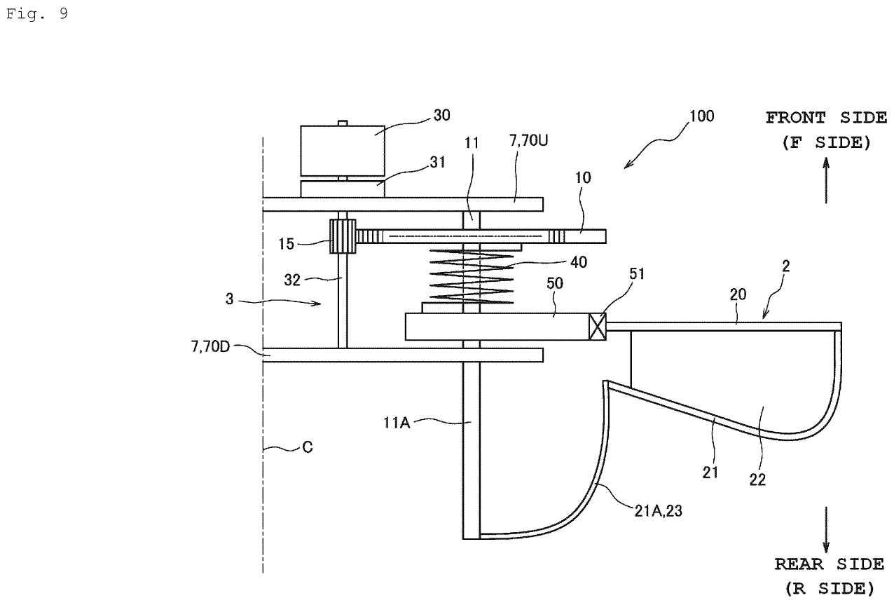

As illustrated in FIG. 11, the flapping device 200 according to the third embodiment has the second vibration excitation member 41 in addition to the configuration of the flapping device 100 according to the second embodiment (see FIG. 9).

As the second vibration excitation member 41, for example, a torsion spring is used. The second vibration excitation member 41 is configured to apply a biasing force to a driven part 10 in a direction opposite to the rotation direction of the driven part 10 in accordance with the rotation of the driven part 10. More specifically, the second vibration excitation member 41 is connected to a body 7 (in this embodiment, a support part 70D) on one end side and is connected to the driven part 10 on the other end side.

The second vibration excitation member 41 is capable of exerting a biasing force that is smaller than a biasing force of the first vibration excitation member 40 and is capable of exerting a biasing force that can return the amplitude center of the first vibration excitation member 40 to the reference position. For example, a torsion spring with a smaller spring coefficient than that of the first vibration excitation member 40 is used as the second vibration excitation member 41. For this reason, the influence of the second vibration excitation member 41 on the first vibration excitation member 40 is limited.

Here, as the spring coefficient of the second vibration excitation member 41, any of various spring coefficients that can exert a biasing force capable of returning the amplitude center of the first vibration excitation member 40 to the reference position can be used. The spring coefficient of the second vibration excitation member 41 may be determined by considering the balance between the effect on the first vibration excitation member 40 and the biasing force for returning the amplitude center to the reference position.

In this way, even when the one end side of the first vibration excitation member 40 is formed as a free end, the flapping device 200 according to the third embodiment can return the amplitude center of the first vibration excitation member 40 to the reference position (scheduled amplitude center). For this reason, according to the flapping device 200 described above, even higher precision and stability of control can be expected.

Incidentally, the torsion spring used in the flapping devices 1, 100, 200 (hereinafter also simply referred to as a flapping device 1 and the like) may gradually open its natural angle over time, for example, due to factors such as initial stress irregularities. For this reason, in the flapping device 1 and the like, as the natural angle of the torsion spring opens, the stroke center of the blade 2 may deviate either forward or backward, and there is a likelihood that the pitch-direction torque balance may be lost. For this reason, in order to further optimize the torque balance according to the use of the torsion spring in the flapping device 1 and the like, the configuration may be further optimized with the characteristics of the torsion spring taken into account.

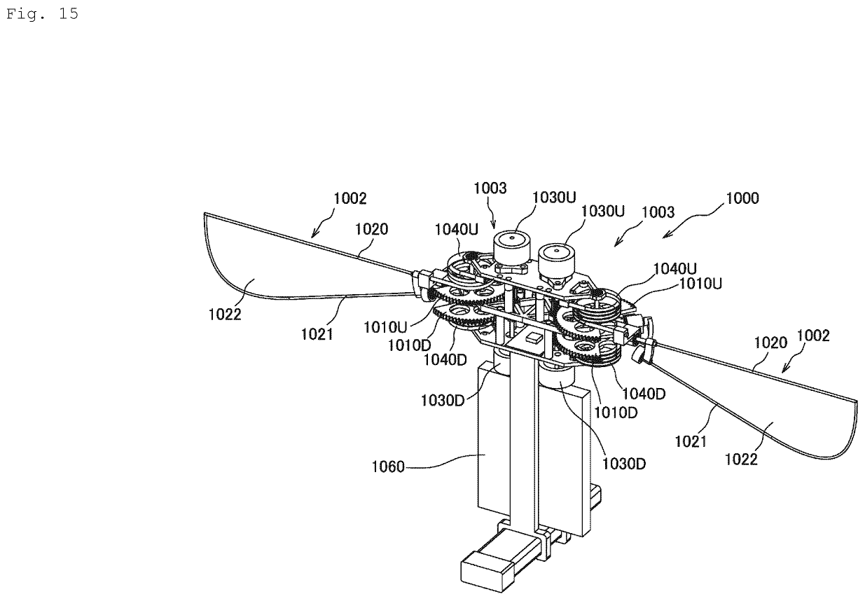

In addition to the flapping device 1 of degree of freedom 1 described above and the like, a flapping device having higher mobility in which the degree of freedom of the blade 2 is increased to degree of freedom 2 may be also considered. More specifically, a flapping device 1000 illustrated in FIG. 15 may be considered. The flapping device 1000 has blades 1002, 1002 and a pair of drive units 1003, 1003 disposed in correspondence with the blades 1002, 1002, and the drive unit 1003 includes a first drive source 1030U, a second drive source 1030D, a first driven part 1010U rotated around a first rotation axial line by the first drive source 1030U, a second driven part 1010D rotated around a second rotation axial line by the second drive source 1030D, a first vibration excitation member 1040U biasing the first driven part 1010U in a direction opposite to the rotation direction of the first driven part 1010U, a second vibration excitation member 1040D biasing the second driven part 1010D in a direction opposite to the rotation direction of the second driven part 1010D, and a control unit 1060. The blade 1002 has a first blade shaft 1020 that is connected to the first driven part 1010U and can rotate around a third rotation axial line intersecting the first rotation axial line, a second blade shaft 1021 that is connected to the second driven part 1010D and can rotate around a fourth rotation axial line intersecting the second rotation axial line, and a blade main body 1022. As in the flapping device 1000 illustrated in FIG. 15, also in a flapping device having high mobility, any one or both of the first vibration excitation member 1040U and the second vibration excitation member 1040D (in the example illustrated in the drawing, both the first vibration excitation member 1040U and the second vibration excitation member 1040D) can be configured using a torsion spring.

In such a flapping device having high mobility (for example, the flapping device 1000), in addition to the flapping device 1 described above and the like, for example, the center of the blade 2 may deviate in any one of upward/downward directions. For this reason, in a flapping device having high mobility such as the flapping device 1000 or the like, there is a likelihood that the center position of the angle of attack of the blade 2 deviates, and the balance of thrusts in forward/backward directions may be lost. For this reason, in a case in which the mobility is configured to be high while employing a torsion spring as in the flapping device 1000, the configuration may be further optimized with the characteristics of the torsion spring taken into account.

In addition, in the flapping device 1 and the like described above and the flapping device 1000 having high mobility, there is concern that, as the torsion spring is opened, the diameter of the torsion spring increases, and the spring constant decreases as that much, which leads to a decrease in the resonant frequency in the flapping movement. As a result, the lift force of the flapping device 1 and the like decreases, and there is a likelihood that the lift stability and the like of the flapping device 1 and the like would be reduced. For this reason, as in the flapping device 1 and the like and the flapping device 1000 and the like, in order to further improve the lift stability caused by the characteristics of a torsion spring while employing the torsion spring, the configuration may be further optimized with the characteristics of the torsion spring taken into account.

In addition, a torsion spring has a property in which the spring constant is different in the rotation direction of a closing direction and the rotation direction of a loosening direction. In accordance with this, even in a case in which initial irregularities do not occur, the pitch-direction torque balance may be lost as described above, or the balance of thrusts may be lost, and there is a problem in that there is a likelihood of the presence of an influence on the operation stability due to the characteristics unique to torsion springs in flapping devices employing torsion springs such as the flapping device 1 and the like and the flapping device having high mobility (for example, the flapping device 1000).

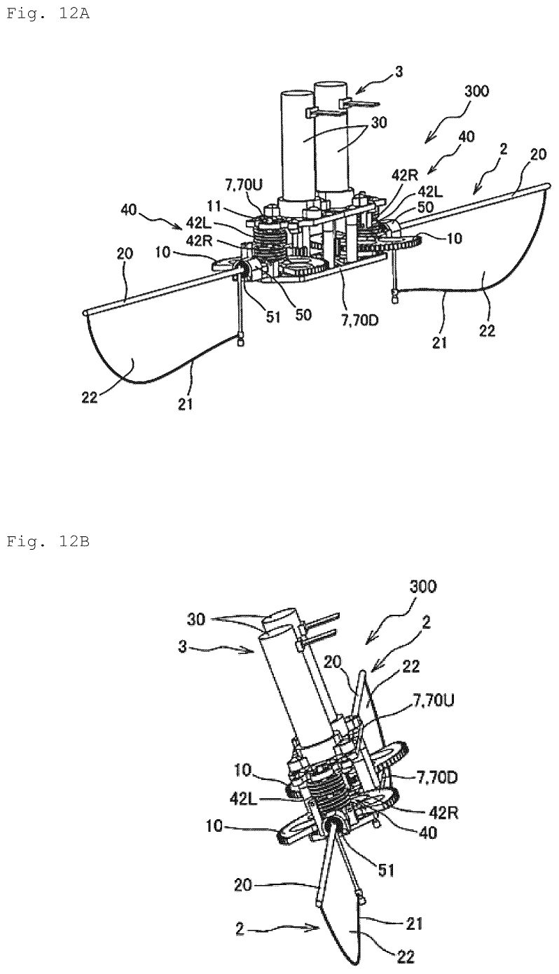

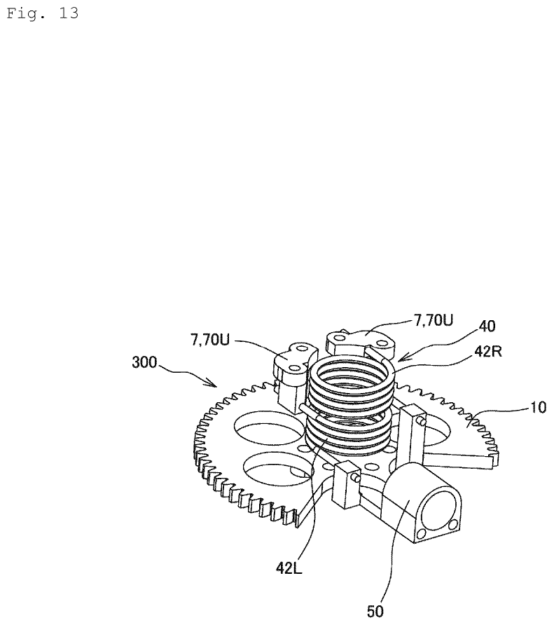

Thus, in a flapping device 300 according to a fourth embodiment, as illustrated in FIGS. 12 and 13 (an enlarged perspective view near a first vibration excitation member 40 on the right side in FIG. 12), the first vibration excitation member 40 is configured as a pair of torsion springs 42L, 42R, and the torsion springs are connected in parallel such that torsional directions thereof are opposite to each other. Hereinafter, details of the flapping device 300 according to the fourth embodiment will be described. The flapping device 300 according to the fourth embodiment is acquired by dividing the first vibration excitation member 40 of the flapping device 1 according to the first embodiment into a pair of torsion springs 42L, 42R, and thus description of parts similar to those of the flapping device 1 according to the first embodiment is omitted. In addition, since the flapping device 300 according to the fourth embodiment is horizontally symmetrically configured, one side will be described, and description of the other side is omitted.

### Fourth Embodiment

As illustrated in FIGS. 12(a), 12(b), and 13, the first vibration excitation member 40 is formed by being divided into the pair of torsion springs 42L, 42R. The pair of torsion springs 42L, 42R are configured to have equivalent spring constants. The pair of torsion springs 42L, 42R are connected in parallel such that torsional directions thereof are opposite to each other (also referred to as opposite windings). More specifically, the pair of torsion springs 42L, 42R are arranged in a vertical direction with a first rotation shaft 11 used as its center such that torsional directions thereof are opposite to each other.

In the pair of torsion springs 42L, 42R, one end sides thereof are connected to a driven part 10 such that torsional directions thereof are opposite to each other, and the other end sides are connected to a body 7 such that torsional directions thereof are opposite to each other. Thus, the pair of torsion springs 42L, 42R can apply biasing forces in a direction opposite to the rotation direction of the driven part 10 to the driven part 10 in accompaniment with the rotation of the driven part 10. Here, a connection position of one or both the one end side and the other end side of each of the torsion springs 42L, 42R may be configured to be adjustable. In accordance with this, the torsion springs 42L, 42R can respectively adjust initial opening angles. In addition, the other end side of the torsion springs 42L, 42R not only may be directly connected to the body 7 but may be indirectly connected thereto.

In the fourth embodiment, when the spring constant of the first vibration excitation member 40 according to the first embodiment is denoted by K, the spring constant of each of the torsion springs 42L, 42R is configured to be a half thereof, which is denoted by (½)K. In other words, each of the torsion springs 42L, 42R is configured to have a spring constant of (½)K that is a half of the spring constant K of the first vibration excitation member 40 before division (also referred to as the original first vibration excitation member 40). Thus, by connecting the torsion springs 42L, 42R in parallel such that the torsional directions thereof are opposite to each other, the torsion springs 42L, 42R have the spring constant K that is equivalent to that of the original first vibration excitation member 40 in a combined state. In accordance with this, the torsion springs 42L, 42R can apply the same biasing force as that of the original first vibration excitation member 40 in a direction opposite to the rotation direction of the driven part 10 to the driven part 10 in accompaniment with the rotation of the driven part 10.

Although, in the flapping device 300 according to the fourth embodiment, the first vibration excitation member 40 has the pair of torsion springs 42L, 42R, the torsion springs 42L, 42R may be configured using two or more pair of torsion springs 42L, 42R as long as they are formed in an even number. In such a case, the spring constants of the torsion springs 42L, 42R may be equally divided in accordance with the number of the springs. The spring constants may be changed to various values in accordance with the form of the flapping device 300. The configuration of the flapping device 300 according to the fourth embodiment can be used also in the form of the flapping device 100 (free-end specifications) according to the second embodiment.

Although not illustrated in the drawing, the first vibration excitation member 1040U and the second vibration excitation member 1040D of the flapping device 1000 having high mobility (see FIG. 15) may be configured using at least one pair of the torsion springs 42L, 42R as in the flapping device 300 according to the fourth embodiment and may be connected in parallel such that torsional directions thereof are opposite to each other. In addition, any one or both of the first vibration excitation member 1040U and the second vibration excitation member 1040D (a member different from the second vibration excitation member 41 according to the third embodiment) may be configured using at least one pair of torsion springs 42L, 42R in accordance with an embodiment.

The configuration of the flapping device 300 according to the fourth embodiment of the present invention has been described as above, and next, operations and effects realized by the flapping device 300 according to the fourth embodiment are described.

As described above, in the flapping device 300 according to the fourth embodiment, the first vibration excitation member 40 has at least one pair of torsion springs 42L, 42R, and the pair of torsion springs 42L, 42R have equivalent spring constants and are connected in parallel such that torsional directions thereof are opposite to each other.

In addition, the flapping device 300 according to the fourth embodiment includes the body 7 that supports the drive unit 3, the first vibration excitation member 40 has at least one pair of torsion springs 42L, 42R, the pair of torsion springs 42L, 42R have equivalent spring constants and are connected in parallel such that torsional directions thereof are opposite to each other, one end sides of the pair of torsion springs 42L, 42R are connected to the driven part 10 such that torsional directions thereof are opposite to each other, and the other end sides thereof are directly or indirectly connected to the body 7 such that the torsional directions thereof are opposite to each other.

By employing the configuration described above, in the flapping device 300 according to the fourth embodiment, loosening directions of the pair of torsion springs 42L, 42R are configured to be directions opposite to each other, and thus the initial stress irregularities can be alleviated. In accordance with this, even in a case in which the natural angle of each of the torsion springs 42L, 42R is opened, the degrees of opening counterbalance each other, and the flapping device 300 can suppress changes in the natural angle of the torsion springs 42L, 42R that are in a combined state.

In addition, by employing the configuration described above, in the flapping device 300 according to the fourth embodiment, the restoring forces of the torsion springs 42L, 42R counterbalance each other, and thus changes in the natural angles thereof can be decreased. In accordance with this, the flapping device 300 can reduce changes in the diameters of the torsion springs 42L, 42R in the combined state and suppress a decrease in the spring constant as a whole. In addition, since the torsion springs 42L, 42R deform in opposite directions regardless of directions of variations, the flapping device 300 can eliminate changes in the spring constant.

In the flapping device 1000 having high mobility, by configuring the first vibration excitation member 1040U and the second vibration excitation member 1040D using at least one pair of torsion springs 42L, 42R as in the fourth embodiment described above and connecting them in parallel with each other, operations and effects that are similar to those according to the fourth embodiment are acquired also in the flapping device 1000 having high mobility. Furthermore, the flapping device 1000 having high mobility can suppress deviations of the center position of the angle of attack of the blade 2 and thus can also suppress loss of the balance of thrusts in the forward and backward directions.

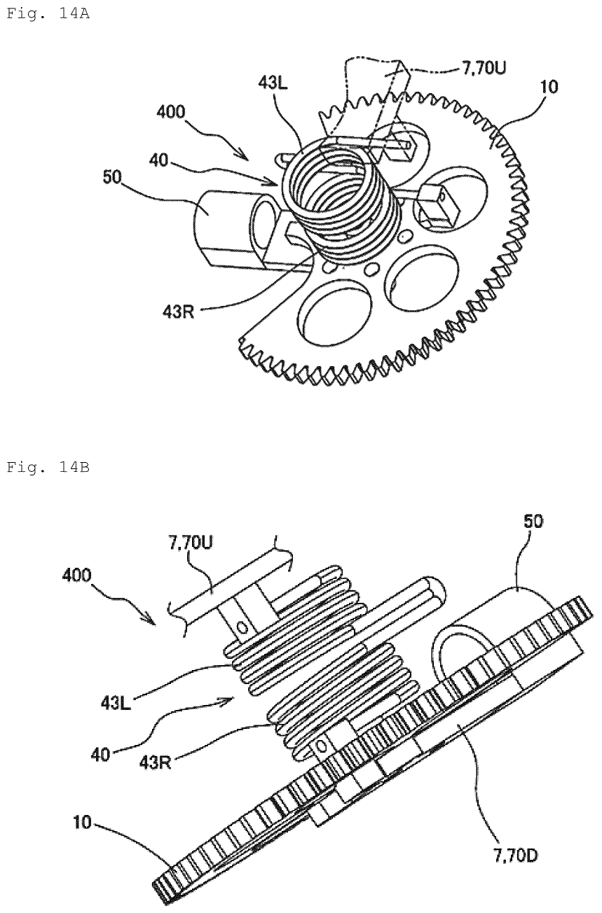

The configuration, the operations and effects of the flapping device 300 according to the fourth embodiment have been described as above, and next, details of a flapping device 400 according to a fifth embodiment in which torsion springs 43L, 43R are connected in series are described below. In addition, the flapping device 400 according to the fifth embodiment is acquired by connecting the torsion springs 43L, 43R of the flapping device 1 according to the fourth embodiment in series, and thus description of the same parts as those of the flapping devices 1, 300 according to the first embodiment and the fourth embodiment are omitted. In addition, the flapping device 400 according to the fifth embodiment is configured to be horizontally symmetrical, and thus one side thereof is described, and description of the other side is omitted. In FIGS. 14(a) and 14(b), although the drive unit 3, the blade 2, the first blade shaft 20, the second blade shaft 21, and the like are omitted, these can be configured similar to those according to the first embodiment to the third embodiment.

### Fifth Embodiment

FIGS. 14(a) and 14(b) are perspective views acquired by enlarging the vicinity of the torsion springs 43L, 43R of the flapping device 400 and cutting out a part thereof. As illustrated in the drawings, a first vibration excitation member 40 is divided into a pair of the torsion springs 43L, 43R. The pair of the torsion springs 43L, 43R are configured to have equivalent spring constants. The pair of the torsion springs 43L, 43R are connected in series such that the torsional directions thereof are the same. More specifically, the pair of the torsion springs 43L, 43R are vertically arranged with a first rotation shaft 11 set as its center such that torsional directions thereof are the same, and one ends thereof are connected, for example, through welding or the like.

The one end side of the torsion springs 43L, 43R that are integrated is connected to the driven part 10, and the other end side thereof is connected to the body 7. Thus, the pair of the torsion springs 43L, 43R can apply biasing forces in a direction opposite to the rotation direction of the driven part 10 to the driven part 10 in accompaniment with the rotation of the driven part 10. Here, a connection position of one or both of the one end side and the other end side of the torsion springs 43L, 43R may be configured to be adjustable. In accordance with this, each of the torsion springs 43L, 43R can adjust the initial opening angle. The other end side of the torsion springs 43L, 43R not only may be directly connected to the body 7 but may be indirectly connected thereto.

In the fifth embodiment, when the spring constant of the first vibration excitation member 40 according to the first embodiment is denoted by K, the spring constant of each of the torsion springs 43L, 43R is configured to be twice the spring constant, which is denoted by 2*K. In other words, each of the torsion springs 43L, 43R is configured to have a spring constant of 2*K that is twice the spring constant K of the first vibration excitation member 40 before division (also referred to as the original first vibration excitation member 40). Thus, by connecting the torsion springs 43L, 43R in series such that the torsional directions thereof are the same, the torsion springs 43L, 43R have the spring constant K that is equivalent to that of the original first vibration excitation member 40 in a combined state. In accordance with this, the torsion springs 43L, 43R can apply the same biasing force as that of the original first vibration excitation member 40 in a direction opposite to the rotation direction of the driven part 10 to the driven part 10 in accompaniment with the rotation of the driven part 10.

Although, in the flapping device 400 according to the fifth embodiment, the first vibration excitation member 40 has the pair of torsion springs 43L, 43R, the torsion springs 43L, 43R may be configured using two or more pair of torsion springs 43L, 43R as long as they are formed in an even number. In such a case, the spring constants of the torsion springs 43L, 43R may be evenly multiplied in accordance with the number of the springs. The spring constants may be changed to various values in accordance with the form of the flapping device 400. The configuration of the flapping device 400 according to the fifth embodiment can be used also in the form of the flapping device 100 (free-end specifications) according to the second embodiment.

Although not illustrated in the drawing, the first vibration excitation member 1040U and the second vibration excitation member 1040D of the flapping device 1000 having high mobility (see FIG. 15) may be configured using at least one pair of the torsion springs 43L, 43R as in the flapping device 300 according to the fifth embodiment and may be connected in series such that torsional directions thereof are the same. In addition, any one or both of the first vibration excitation member 1040U and the second vibration excitation member 1040D (a member different from the second vibration excitation member 41 according to the third embodiment) may be configured using at least one pair of torsion springs 43L, 43R in accordance with an embodiment.

The configuration of the flapping device 400 according to the fifth embodiment of the present invention has been described as above, and next, operations and effects realized by the flapping device 400 according to the fifth embodiment are described.

As described above, in the flapping device 400 according to the fifth embodiment, the first vibration excitation member 40 has at least one pair of torsion springs 43L, 43R, and the pair of torsion springs 43L, 43R have equivalent spring constants and are connected in series such that torsional directions thereof are the same.

In addition, the flapping device 400 according to the fifth embodiment includes the body 7 that supports the drive unit 3, the first vibration excitation member 40 has at least one pair of torsion springs 43L, 43R, the pair of torsion springs 43L, 43R have equivalent spring constants and are connected in series such that torsional directions thereof are the same, one end side of the first vibration excitation member 40 is connected to the driven part 10, and the other end thereof is directly or indirectly connected to the body 7.

By employing the configuration described above, in the flapping device 400 according to the fifth embodiment, the pair of torsion springs 43L, 43R can cancel out mutual reaction forces. For this reason, loosening directions of the pair of torsion springs 43L, 43R can be cancelled out, and thus the initial stress irregularities can be alleviated. In accordance with this, even in a case in which the natural angle of each of the torsion springs 43L, 43R is opened, the degrees of opening counterbalance each other, and the flapping device 400 can suppress changes in the natural angle of the torsion springs 43L, 43R that are in a combined state.

In the flapping device 1000 having high mobility, by configuring the first vibration excitation member 1040U and the second vibration excitation member 1040D using at least one pair of torsion springs 43L, 43R as in the fifth embodiment described above and connecting them in series, operations and effects that are similar to those according to the fifth embodiment are acquired also in the flapping device 1000 having high mobility. Furthermore, the flapping device 1000 having high mobility can suppress deviations of the center position of the angle of attack of the blade 2 and thus can also suppress loss of the balance of thrusts in the forward and backward directions.

Although the configurations and the operations and effects of the flapping devices 1, 100, 200, 300, 400 according to the first embodiment to the fifth embodiment of the present invention have been described above, the flapping device 1, 100, 200, 300, 400 of the present invention are not limited to the embodiments described above, and various modifications can be performed.

For example, the pair of blades 2, 2 can be formed in various shapes and sizes. In this embodiment, although the pair of blades 2, 2 are disposed, the number of blades 2 can be appropriately changed, for example, to two pairs or the like. In such a case, additional drive sources 30 may be installed in correspondence with the blades 2. The first blade shaft 20, the second blade shaft 21, and the blade main body 22 can be formed in various shapes and sizes, and the direction of formation can be appropriately changed.

In this embodiment, although a case in which outrunner motors are used as DC motors in the drive sources 30, 30 is illustrated as an example, various motors and the like capable of exerting a driving force can be used in the drive sources 30, 30. For example, the drive source 30, 30 may configured using in-runner motors as DC motors.

In this embodiment, although a spur gear is used for the driven part 10, and this is driven by the drive gear 15 that is a pinion gear, the present invention is not limited thereto. Various forms of the driven part 10 can be used. For example, the driven part 10 may be formed by a pulley or the like and driven using a belt or the like. The drive gear 15 can also be used not only in the form of a gear but in various forms in accordance with the form of the driven part 10.

In this embodiment, although torsion springs are used as the first vibration excitation member 40 and the second vibration excitation member 41, the vibration excitation members are not limited thereto. The first vibration excitation member 40 and the second vibration excitation member 41 are not limited to torsion springs, but various types thereof can be used. In addition, in this embodiment, although the same type of torsion springs are used as the first vibration excitation member 40 and the second vibration excitation member 41, different types of vibration excitation members can be respectively used as the vibration excitation members. The arrangement of the first vibration excitation member 40 and the second vibration excitation member 41 can be changed in various ways within the scope of the present invention. In this embodiment, although control is performed in an integrated manner by a single control unit 60, the control unit 60 may be composed of multiple units by dividing the control unit by function or the like.

In this embodiment, although the second blade shaft 21 is connected to the first rotation shaft 11 through the suspension part 21A and the extension part 11A, the second blade shaft 21 not only may be connected through the suspension part 21A and the extension part 11A but can be directly or indirectly connected to the first rotation shaft 11 in various forms. In addition, the suspension part 21A and the extension part 11A can be formed in various shapes and sizes in accordance with the direction of formation of the second blade shaft 21.

In this embodiment, although control of stopping the output of the driving force of the drive source 30 is performed at a predetermined time before the rotation speed of the drive source 30 becomes zero, the timing at which the output is stopped can be appropriately changed in accordance with the characteristics of the motor and the like that are used. In this embodiment, although control of resuming the output of the driving force of the drive source 30 is performed at a time point at which the forward movement or the backward movement of the blade 2 is switched in accordance with the restoring force of the first vibration excitation member 40, the timing at which the output of the driving force is resumed can be appropriately changed in accordance with characteristics of the motor and the like that are used. The offset amount in the offset control performed by the control unit 60 can be set to various offset amounts depending on the flight modes of the flapping devices 1, 100, 200.

In this embodiment, although the control unit 60 inclines the blade 2 at a predetermined angle such that the vertical component of a normal-line vector of the blade surface facing in the direction of travel is downward in accordance with a resisting force received by the blade surface (the blade main body 22) of the blade 2, the angle at which the blade 2 is inclined can be set to various angles by changing the setting of the rotation limiter 23 in accordance with a flight mode, flight environments, and the like. The angle at which the blade 2 is inclined, for example, may be adjusted by changing the shape and the size of the suspension part 21A or the material, and the like. The control of the blades 2 is not limited to that of the embodiments described above, and various types of control can be performed depending on the flight mode and the like.

In the fourth embodiment and the fifth embodiment, although examples in which the first vibration excitation member 40 is configured using the torsion springs 42L, 42R (the fourth embodiment) or the torsion springs 43L, 43R (the fifth embodiment) having equivalent spring constants have been illustrated, torsion springs 42L, 42R and torsion springs 43L, 43R of which spring constants are different or shapes, sizes, and the like are different may be used as long as changes in the natural angles of the torsion springs 42L, 42R and the torsion springs 43L, 43R can be suppressed. In addition, the spring constants in a state in which the torsion springs 42L, 42R and the torsion springs 43L, 43R are combined may be set to various values in accordance with a generated biasing force. Furthermore, in the fourth embodiment and the fifth embodiment, although the pair of the torsion springs 42L, 42R and the torsion springs 43L, 43R are used, the torsion springs 42L, 42R and the torsion springs 43L, 43R are not limited to one pair of torsion springs, and may be configured as two or more pair of torsion springs in an even number. In addition, also in the flapping device 1000 having high mobility, a configuration similar to that of the fourth embodiment and the fifth embodiment can be employed.

Although various embodiments and modified example of the flapping device according to the present invention have been described as above, the present invention is not limited to those illustrated in the embodiments and the modified examples described above, and it can be easily understood by those skilled in the art that there are other embodiments from the teachings and spirit thereof in a range not departing from the scope of the claims.

### INDUSTRIAL APPLICABILITY

The flapping device according to the present invention can be used for various types of surveys, repairs, photography, and the like in the air.

### REFERENCE SIGNS LIST

1 Flapping device
2 Blade
3 Drive unit
7 Body
10 Driven part
11 First rotation shaft
11A Extension part
20 First blade shaft
21 Second blade shaft
21A Suspension part
22 Blade main body
23 Rotation limiter
30 Drive source
40 First vibration excitation member
41 Second vibration excitation member
42L Torsion spring
42R Torsion spring
43L Torsion spring
43R Torsion spring
60 Control unit
70U Support part
70D Support part
100 Flapping device
300 Flapping device
300 Flapping device
400 Flapping device

1. A flapping device comprising:
a pair of blades; and
drive units disposed in correspondence with the pair of blades,
wherein the drive unit includes:
a drive source;
a driven part receiving power output from the drive source and rotating around a first rotation axial line;
a first vibration excitation member applying a biasing force to the driven part in a direction opposite to a rotation direction of the driven part in accordance with rotation of the driven part; and
a control unit performing output control of a driving force of the drive source, and
wherein the blade has:
a first blade shaft extending in a predetermined axial line direction and being connected to the driven part on a one end side and connected to be rotatable in a second rotation axial line surrounding direction intersecting the first rotation axial line;
a second blade shaft extending in a direction intersecting the first blade shaft and being directly or indirectly connected to the driven part on a one end side and connected to be rotatable in the first rotation axial line surrounding direction; and
a blade main body disposed over the first blade shaft and the second blade shaft.

2. A flapping device comprising:
a pair of blades; and
drive units disposed in correspondence with the pair of blades,
wherein the drive unit includes:
a drive source;
a driven part receiving power output from the drive source and rotating around a first rotation axial line;
a first vibration excitation member applying a biasing force to the driven part in a direction opposite to a rotation direction of the driven part in accordance with rotation of the driven part; and
a control unit performing output control of a driving force of the drive source,
wherein the blade has:
a first blade shaft extending in a predetermined axial line direction and being connected to the driven part on a one end side and connected to be rotatable in a second rotation axial line surrounding direction intersecting the first rotation axial line;
a second blade shaft extending in a direction intersecting the first blade shaft and being directly or indirectly connected to the driven part on a one end side and connected to be rotatable in the first rotation axial line surrounding direction; and
a blade main body disposed over the first blade shaft and the second blade shaft, and
wherein the first vibration excitation member is connected to the driven part on a one end side and is directly or indirectly connected to the first blade shaft on the other end side.

3. The flapping device according to claim 1, wherein the drive source is configured using an outrunner motor as a DC motor.

4. The flapping device according to claim 1,
wherein the control unit:
performs control of stopping output of driving force of the drive source before a predetermined time at which a rotation speed of the drive source becomes zero in switching between forward rotation or backward rotation of the drive source and control of resuming the output of the driving force of the drive source after a predetermined time at which forward movement or backward movement is switched in the blade in accordance with a restoring force of the first vibration excitation member.

5. The flapping device according to claim 1,
wherein the control unit is able to execute offset control of offsetting an amplitude center of the first vibration excitation member to one side or the other side around the first rotation axial line by a predetermined amount; and
wherein the offset control is executed by applying a predetermined amount of offset to a drive voltage waveform of the drive source.

6. The flapping device according to claim 1, wherein the blade has a rotation limiter for maintaining an inclination at a predetermined angle such that a vertical component of a normal-line vector of a blade surface facing a direction of travel points downward by receiving a resistance force according to a wind pressure generated in accordance with a relative speed difference between movement of the blade and a surrounding fluid.

7. The flapping device according to claim 2, further comprising:
a body supporting the drive unit; and
a second vibration excitation member applying a biasing force to the driven part in a direction opposite to the rotation direction of the driven part in accordance with rotation of the driven part, and
wherein the second vibration excitation member is connected to the body on a one end side and is directly or indirectly connected to the first blade shaft on the other end side, and
wherein the second vibration excitation member is formed to be able to exert a biasing force that is smaller than the biasing force of the first vibration excitation member and exert a biasing force capable of returning the amplitude center of the first vibration excitation member to a reference position.

8. The flapping device according to claim 1, further comprising:
a body supporting the drive unit,
wherein the body has a pair of support parts disposed spaced apart from each other,
wherein the drive source is arranged outside of the pair of support parts, and
wherein the first vibration excitation member and the driven part are arranged between the pair of support parts.

9. The flapping device according to claim 1,
wherein an extension part is formed to extend in the first rotation axial line direction on the one end side of the first rotation axial line,
wherein the second blade shaft has a suspension part formed to extend toward the extension part on the one end side, and
wherein the suspension part is connected to the extension part on a one end side and is rotatable in the first rotation axial line surrounding direction integrally with the extension part.

10. The flapping device according to claim 1,
wherein the first vibration excitation member has at least one pair of torsion springs, and
wherein the pair of torsion springs have equivalent spring constants and are connected in parallel such that torsional directions are opposite to each other.

11. The flapping device according to claim 1, further comprising:
a body supporting the drive unit,
wherein the first vibration excitation member has at least one pair of torsion springs,
wherein the pair of torsion springs have equivalent spring constants and are connected in parallel such that torsional directions are opposite to each other, and
wherein the pair of torsion springs have a one end side being connected to the driven part such that the torsional directions are opposite to each other and the other end side being directly or indirectly connected to the body such that the torsional directions are opposite to each other.

12. The flapping device according to claim 1,
wherein the first vibration excitation member has at least one pair of torsion springs, and
wherein the pair of torsion springs have equivalent spring constants and are connected in series such that torsional directions are the same.

13. The flapping device according to claim 1, further comprising:
a body supporting the drive unit,
wherein the first vibration excitation member has at least one pair of torsion springs,
wherein the pair of torsion springs have equivalent spring constants and are connected in series such that torsional directions are the same, and
wherein the first vibration excitation member has a one end side being connected to the driven part and the other end side being directly or indirectly connected to the body.
